(19) United States
(12) Patent Application Publication
(10) Pub. No.: US 2009/0043666 A1
(43) Pub. Date: Feb. 12, 2009

(54) GENERATION OF WIRELESS NETWORK PLANNING REPORTS WITH SKU AND PRICING DATA

(75) Inventors: Ajay MALIK, Santa Clara, CA (US); Mahender VANGATI, San Jose, CA (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 11/837,048

(22) Filed: Aug. 10, 2007

(51) Int. Cl. G06Q 10/00; G06F 17/30; G06Q 30/00

(52) U.S. Cl. 705/26; 705/1

(57) ABSTRACT

A wireless network architecture planning system and related operating methods are disclosed herein. The planning system generates a report for a recommended wireless network architecture for a proposed floor plan, where the report contains product identifier codes (e.g., SKUs) for wireless infrastructure components and related accessories. An embodiment of the planning system executes a computer-implemented method that receives floor plan data corresponding to the site, produces a proposed wireless network architecture for the site, obtains product identifier codes corresponding to wireless infrastructure components needed to deploy the recommended wireless network architecture, and generates a report that lists the product identifier codes.

### TECHNICAL FIELD

Embodiments of the subject matter described herein relate generally to a planning and management software application for use with wireless network architectures. More particularly, embodiments of the subject matter relate to the generation of a wireless network planning report that contains stock keeping unit (SKU) and price information for wireless network devices and accessories.

### BACKGROUND

Wireless radio frequency (RF) network architectures, wireless local area networks (WLANs), and wireless network devices and accessories are becoming increasingly popular. WLANs can give mobile computing clients the ability to “roam” or physically move from place to place without being connected by wires. In the context of a WLAN, the term “roaming” describes the act of physically moving between wireless access devices, which may be stand-alone wireless access points or wireless access ports that cooperate with one or more wireless switches located in the WLAN. Many deployments of wireless computer infrastructure, such as WLANs, involve the use of multiple wireless switches serving a number of wireless access devices.

Some wireless network administrators utilize software-based tools for purposes of planning, managing, diagnosing, and monitoring WLANs. Planning features in software of this type can generate RF coverage maps in conjunction with the floor plan in which the WLAN will be deployed. Such planning features allow the network administrator to determine how best to provide for RF coverage in the floor plan. In addition, WLAN planning software typically includes a reporting feature that can be used to generate a listing of devices needed to deploy the proposed WLAN.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a WLAN that employs a wireless switch and wireless access ports;

FIG. 2 is a schematic representation of an embodiment of a WLAN that employs wireless access points;

FIG. 3 is a floor plan diagram that represents a site for a wireless network architecture;

FIG. 4 is a schematic representation of an embodiment of a computing device configured to run a software application for planning a WLAN;

FIG. 5 is a flow chart that illustrates an embodiment of a WLAN planning process;

FIG. 6 is a simplified representation of a device layout report generated by an embodiment of a WLAN planning system; and

FIG. 7 is a simplified representation of a product listing report generated by an embodiment of a WLAN planning system.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

For the sake of brevity, conventional techniques related to WLAN design, topologies, and operation, inventory control, computer science, computer programming, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the subject matter.

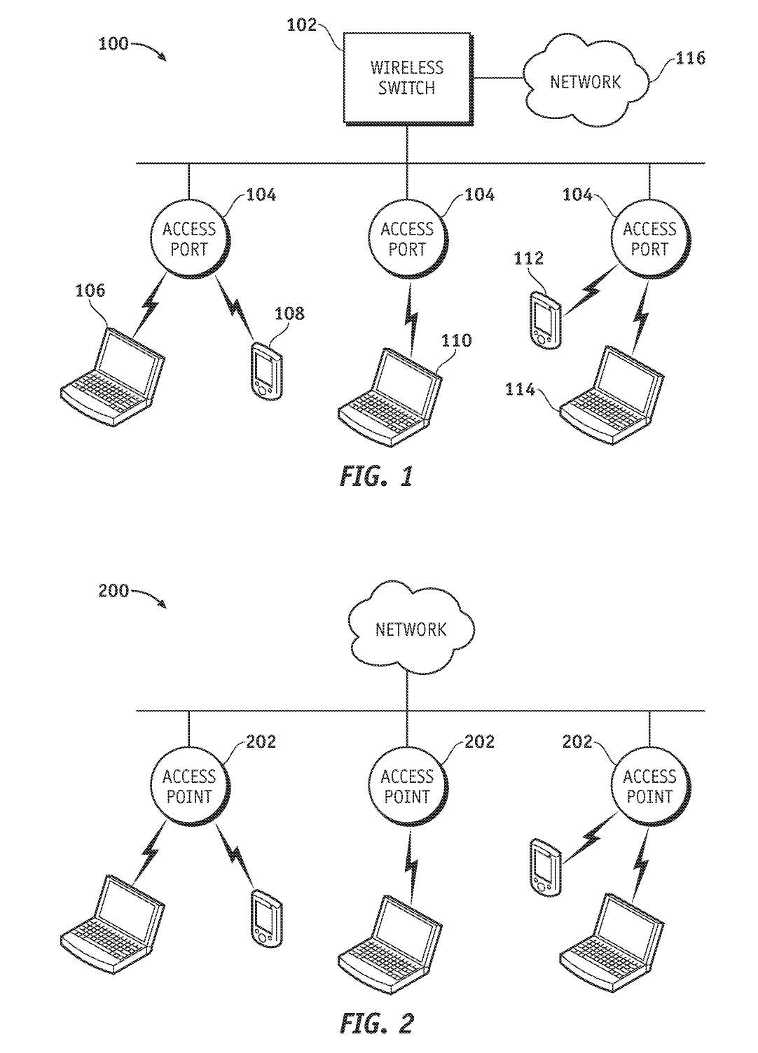

FIG. 1 is a schematic representation of an embodiment of a WLAN 100 that employs a wireless switch 102 and wireless access ports 104. WLAN 100 can support wireless clients or MUs (identified by reference numbers 106, 108, 110, 112, and 114) using wireless access ports 104. As used here, a wireless access port represents one embodiment of a wireless access device. WLAN 100 may also include or communicate with any number of additional network components, such as a traditional local area network (“LAN”). In FIG. 1, such additional network components are generally identified by reference number 116. A practical embodiment can have any number of wireless switches (including zero), each supporting any number of wireless access devices, and each wireless access device supporting any number of wireless clients. Indeed, the topology and configuration of WLAN 100 can vary to suit the needs of the particular application and FIG. 1 is not intended to be limiting in any way.

In this example, the wireless access devices are realized as wireless access ports 104, which are “thin” devices that rely on the network intelligence and management functions provided by wireless switch 102. In contrast, FIG. 2 is a schematic representation of an embodiment of a WLAN 200 that employs wireless access points 202, which are “thick” devices having the network intelligence and processing power integrated therein. Thus, wireless access points 202 need not rely upon a wireless switch for operation. As used here, a wireless access point represents another embodiment of a wireless access device. Wireless access ports 104 and wireless access points 202 may be conventional in configuration and operation, and such wireless access devices are available from Motorola, Inc. and other suppliers. Briefly, a wireless access device as described herein is suitably configured to receive data from wireless clients over wireless links. Once that data is captured by the wireless access device, the data can be processed for communication within WLAN 100 or WLAN 200. For example, the data can be encapsulated into a packet format compliant with a suitable data communication protocol. In certain embodiments, data is routed within a WLAN using conventional Ethernet 802.3 addressing (including standard Ethernet destination and source packet addresses).

Referring again to FIG. 1, wireless switch 102 may be coupled to an Ethernet switch (not shown), which is in turn coupled to wireless access ports 104. In practice, wireless switch 102 communicates with wireless access ports 104 via the Ethernet switch. A given wireless switch can support any number of wireless access devices, i.e., one or more wireless access devices can be concurrently adopted by a single wireless switch (in the exemplary embodiment, a wireless access device can be adopted by only one wireless switch at a time). The wireless clients are wireless devices that can physically move around the network environment and communicate with network components 116 via wireless access ports 104.

A WLAN management and planning system of the type described herein can generate RF coverage maps to display optimal device placement as an aid to planning, while other graphs indicate network health at a glance. Users can view the status and location of wireless infrastructure devices and clients, search for a specific piece of equipment, identify rogue access devices, troubleshoot network issues, generate reports, etc. Statistics such as RF coverage, load balancing, redundancy, security threat levels, and network utilization can be graphically displayed, allowing network administrators to instantly access network status. Moreover, the management and planning system provides a suitably formatted report that contains a parts list, SKU information, and/or pricing information that facilitates quick and easy ordering of products needed to support a planned WLAN deployment.

The WLAN management and planning system is a software-based application that provides users with the functionality to research and define the physical design and intended performance of their RF infrastructure. The system can output a set of component placement recommendations based on a user-provided floor plan. The floor plan is used to generate coverage areas to expose areas of RF interference that should be taken into consideration when making component placement recommendations. The system reduces the dependency on costly manual site surveys prior to installation of a WLAN. The system can conduct RF coverage calculations and equipment placement scenarios to optimize RF coverage in certain predefined areas. The system allows network administrators to design a WLAN before actually dispatching a technician and before actually purchasing a wireless switch, an antenna, or a wireless access device.

The system creates a coverage area template based upon an image of the desired floor plan. This template can be revised to include infrastructure devices, mobile units (MUs), and/or known RF barriers such as walls, obstructions, or large metal structures. The system can then be manipulated by the user to define new coverage areas, generate an updated floor plan, and display device locations and projected coverage zones. The system can leverage a library of attenuators for different building materials to ensure that the characteristics of the RF coverage area can be accurately modeled. This library can be utilized to ensure that the expected signal strength of a device is properly impacted by the RF attenuation associated with the actual building materials and obstacles.

The system can be suitably configured to support the product line of one or more vendors, manufacturers, resellers, etc. In certain embodiments, the system focuses on WLAN products offered by one manufacturer, for example, Motorola, Inc. In other embodiments, the system can be configured to recommend products from multiple sources. The system can be populated with (or have access to) the WLAN product line database, which may include products such as, without limitation: wireless switches; wireless access devices (i.e., wireless access points and wireless access ports); bridges; adapters; repeaters; mobile computing devices; RFID readers; antennas; power cables; interconnect cables; mounting devices; UWB sensors; time synchronization devices; ZigBee routers; and related accessories.

The subject matter described herein relates to the planning, reporting, and order facilitating features of a WLAN management and planning system. These features enable easy planning of WLAN installations, and allow a network administrator to quickly review a recommended product list that includes model numbers, SKU codes, and pricing information for the recommended infrastructure products.

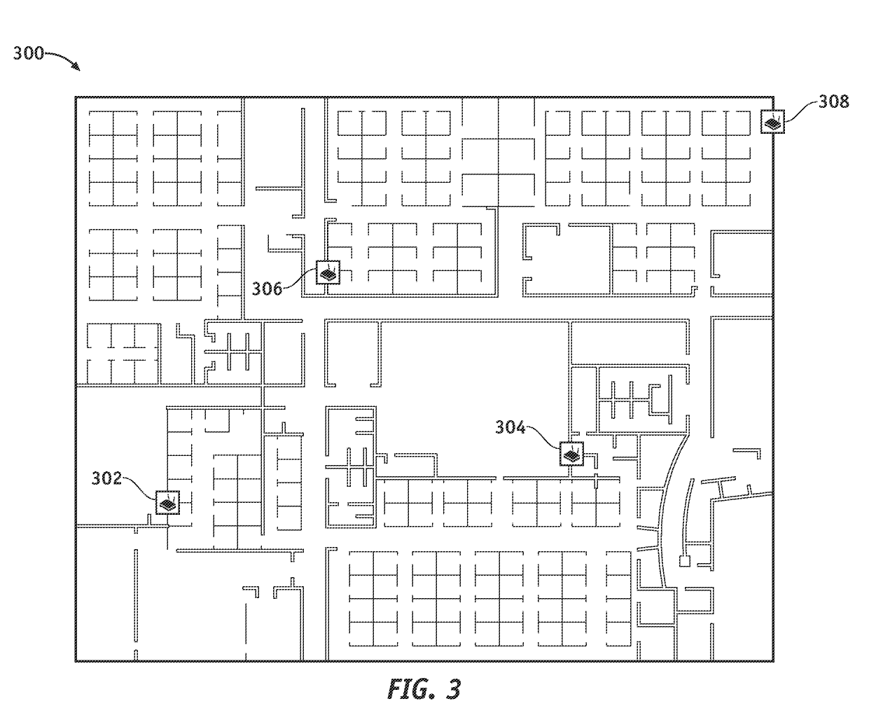

FIG. 3 is a floor plan diagram 300 that represents a site for a wireless network architecture. The WLAN planning system described here is suitably configured to produce a proposed wireless network architecture for a given site and floor plan. The number of possible floor plans is unlimited, and floor plan diagram 300 is merely one suitable example. For this example, the proposed wireless network architecture includes a plurality of wireless infrastructure components, namely, four wireless access devices (reference numbers 302, 304, 306, and 308). These wireless access devices may be realized as wireless access points, wireless access ports, or a combination thereof. Using known techniques and methodologies, the WLAN planning system provides a recommended arrangement of wireless infrastructure components that satisfies the desired wireless coverage characteristics and requirements for the site. In certain embodiments, the system generates a display and/or a printout of the floor plan, with the locations of the wireless infrastructure components superimposed on the floor plan, as generally depicted in FIG. 3.

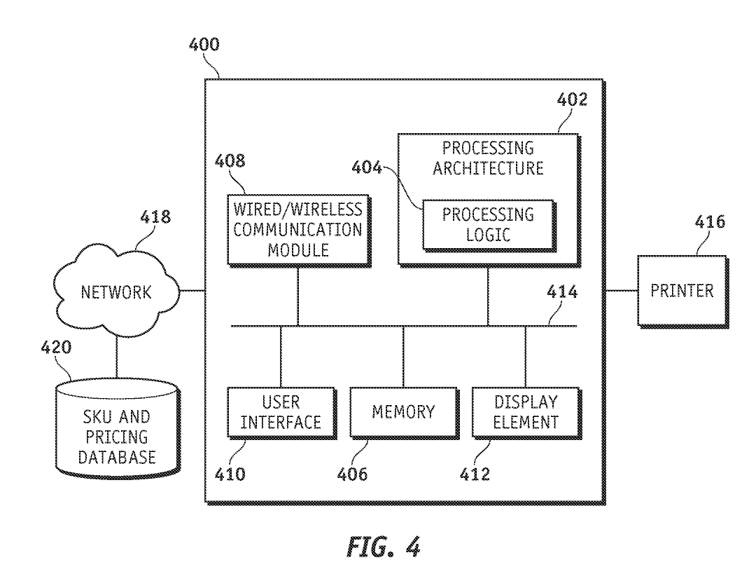

As mentioned previously, the WLAN planning system described here can be realized as a computer-executed software application that resides at one or more computing devices. Depending upon the implementation, the application may be: a standalone application that is designed to run on a computing device having no network connectivity; a web browser based application hosted by one or more servers; a shared application; a standalone application that is designed to run on a computing device having network connectivity to an external database; or the like. In this regard, FIG. 4 is a schematic representation of a computing device 400 that is suitably configured to perform various WLAN management and planning processes. Computing device 400 may be implemented in any suitable form factor, including, without limitation: a personal computer, a server computer, a portable computer, a personal digital assistant, a networked computer, or a distributed computing device. Computing device 400 may be described in the general context of computer-executable instructions, such as program modules, application code, or software executed by one or more processing elements or other devices. Generally, program modules include routines, programs, objects, components, data structures, and/or other elements that perform particular tasks or implement particular abstract data types. Typically, the functionality of the program modules may be combined or distributed as desired in various embodiments.

Computing device 400 typically includes at least some form of computer readable media. Computer readable media can be any available media that can be accessed by computing device 400 and/or by applications executed by computing device 400. By way of example, and not limitation, computer readable media may include computer storage media and communication media. Computer storage media includes volatile, nonvolatile, removable, and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 400. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

Computing device 400 generally includes a processing architecture 402 (e.g., one or more processors) having suitably configured processing logic 404, a suitable amount of memory 406, at least one communication module 408, user interface features 410, and a display element 412. These elements may be interconnected using a data/control bus 414 or any suitably configured interconnection architecture or arrangement.

Processing architecture 402 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor may be realized as a microprocessor, a controller, a microcontroller, or a state machine. Moreover, a processor may be implemented as a combination of computing devices, e.g., a combination of a digital signal processor and a microprocessor, a plurality of microprocessors, one or more microprocessors in conjunction with a digital signal processor core, or any other such configuration.

Memory 406 may be volatile (such as RAM), non-volatile (such as ROM, flash memory, etc.) or a combination thereof. In this regard, memory 406 can be coupled to processing architecture 402 such that processing architecture 402 can read information from, and write information to, memory 406. In the alternative, memory 406 may be integral to processing architecture 402. As an example, processing architecture 402 and memory 406 may reside in an ASIC. Computing device 400 may also have additional storage (removable and/or non-removable) including, but not limited to, magnetic or optical disks or tape. Memory 406, removable storage, and non-removable storage are all examples of computer storage media as defined above.

For the embodiments described here, processing architecture 402 cooperates with memory 406 to support a computer-readable medium having stored thereon computer-executable instructions for performing a method of planning a wireless network architecture for a desired site. Thus, memory 406 can be used to store a suitably configured software application that is executed by processing architecture 402 in a manner that supports the techniques, methodologies, and processing tasks described in more detail herein.

Communication module 408, which may utilize wired and/or wireless data communication interfaces and protocols, allows computing device 400 to communicate with other devices or elements, such as a printer 416, a data communication network 418, and/or a remote database 420. In embodiments described herein, communication module 408 may include, without limitation, suitably configured interfaces that allow computing device 400 to communicate with network 418 (e.g., the Internet), external databases such as remote database 420, external memory devices, and the like. Communication module 408 may be associated with the handling of communication media as defined above.

Computing device 400 may also include or communicate with user interface features 410 such as a keyboard, mouse or other pointing device, pen, voice input device, touch input device, etc. Computing device 400 may also include or communicate with output device(s) such as display element 412, speakers, printer 416, or the like. All of these components are well known in the art and need not be discussed at length here.

In this embodiment, remote database 420 contains data indicative of product identifier codes (e.g., SKUs, bar code numbers, universal price codes (UPCs), or the like), pricing data that represents the current prices for the wireless infrastructure components, and model identifier codes (e.g., model numbers, product names, or the like). Remote database 420 can be controlled and managed by any suitably configured database management system such that the data provided by remote database 420 to computing device 400 is formatted in an appropriate manner.

Alternatively (or additionally), memory 406 of computing device 400 serves as an embedded preloaded database for the WLAN planning system. In such an embodiment, some or all of the data mentioned above in the context of remote database 420 can be stored in the embedded database. Such an embedded database can be updated as needed using portable storage media (such as a CD-ROM), a programming device coupled to computing device 400, a downloading procedure that leverages the Internet or another network to which computing device 400 is coupled, or the like. Alternatively (or additionally), computing device 400 can be configured to access a database that resides on a portable storage media (such as a CD-ROM). Such on-demand access to a database stored on a disk may be desirable to ensure that confidential data does not remain in memory 406.

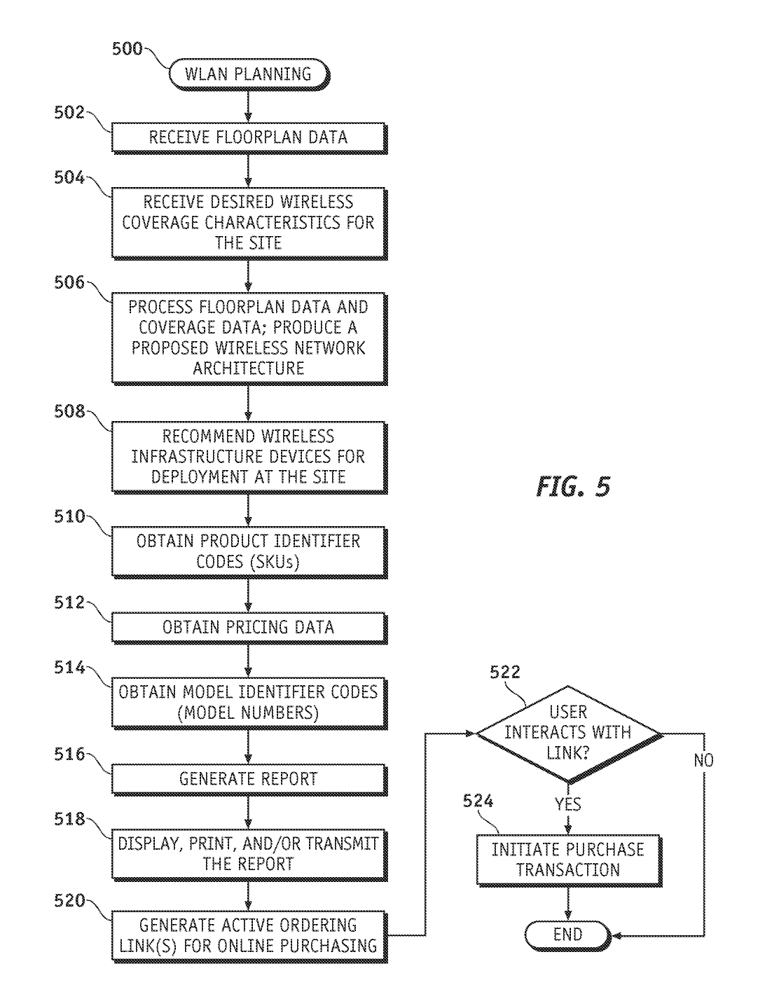

FIG. 5 is a flow chart that illustrates an embodiment of a WLAN planning process 500, which may be performed by any general purpose computer, such as computing device 400. The various tasks performed in connection with process 500 may be performed by software, hardware, firmware, or any combination thereof. For illustrative purposes, the following description of process 500 may refer to elements mentioned above in connection with FIGS. 1-4. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein.

WLAN planning process 500 may begin by receiving floor plan data corresponding to the site of interest (task 502). As an example, FIG. 3 depicts a floor plan for which floor plan data can be uploaded for processing by process 500. In practice, the floor plan data is received as a suitably formatted image file. Process 500 may also receive the desired wireless coverage characteristics and/or requirements for the site (task 504). Task 504 may represent manipulation of the software application by a user, wherein the user can designate the types of wireless infrastructure components needed for the WLAN, the preferred RF coverage zones, and potential locations for components (e.g., access points, antennas, and bridges). Process 500 can then process the floor plan data, the wireless coverage data, and possibly other user inputs to produce a proposed wireless network architecture that is deployable using various wireless infrastructure components (task 506). In this regard, the proposed wireless network architecture is generated in response to the floor plan data and in response to the desired wireless coverage characteristics for the site. In practice, process 500 recommends one or more wireless infrastructure devices for deployment at the site (task 508). In connection with task 508, process 500 may generate a display and/or a printout of the floor plan with graphical icons that represent the recommended components and their approximate installation locations (see FIG. 3). In connection with task 508, process 500 may display and/or print a table or report that summarizes the recommended wireless network architecture and its devices (see FIG. 6). For purposes of task 508, process 500 can be designed to exclusively recommend or favor products that are manufactured, sold, maintained, or distributed by certain companies. For example, process 500 may be suitably designed to only recommend wireless network infrastructure devices that are available from Motorola, Inc.

For this embodiment, task 508 recommends wireless infrastructure components along with their associated accessories (which may be optional or required). For example, task 508 can recommend a wireless access device and accessories for the wireless access device, such as, without limitation: adapter cables; compatible antennas; mounting hardware; power supplies; weather proofing kits; or the like. As another example, task 508 can recommend a wireless switch device and related accessories, including, without limitation: PoE switches; L2 hubs; and Ethernet switches. As yet another example, task 508 might recommend a radio antenna and its associated accessories, such as, without limitation: mounting hardware and fixtures; and interconnect cables/wires.

In a practical deployment, an embodiment of WLAN planning process 500 may also support a number of features and operations, many of which are conventional in nature. For example, process 500 might be suitably designed to support one or more of the following features, without limitation: WLAN management; troubleshooting; network monitoring; RF heat mapping; key performance indicator (KPI) graphing; identification of rogue access devices; and displaying network related statistics.

WLAN planning process 500 is suitably designed to obtain one or more of the following items: product identifier codes corresponding to the recommended wireless infrastructure components and accessories (task 510); pricing data for the recommended wireless infrastructure components and accessories (task 512); and model identifier codes for the recommended wireless infrastructure components and accessories (task 514). As described above, the computing device that executes process 500 can obtain this information from: an embedded local database; an attached local database; a remote database, which may be accessed via a network such as the Internet; a portable storage medium; or the like. Thereafter, process 500 can analyze, format, or otherwise process this information as needed.

Eventually, WLAN planning process 500 generates a report (task 516) that is suitably formatted for review by a user. The report may be rendered as a PDF file, a JPEG image file, a file compatible with a word processing application, a file compatible with a spreadsheet application, or the like. In certain embodiments, this report lists the product identifier codes (e.g., SKUs) for the recommended wireless infrastructure components and any identified accessories. This listing enables the user to easily place an order for the recommended components and accessories by referring to their SKUs. In certain embodiments, the report may also include quantity data for the respective wireless infrastructure components and any recommended accessories. For example, the wireless network architecture depicted in FIG. 3 has four wireless access devices. If all four of these devices represent the same product (i.e., they all share the same model number and SKU), then the report may indicate that four units are required for the recommended layout. In certain embodiments, the report may also include the associated model identifier codes (e.g., model numbers) for the recommended wireless infrastructure components and accessories.

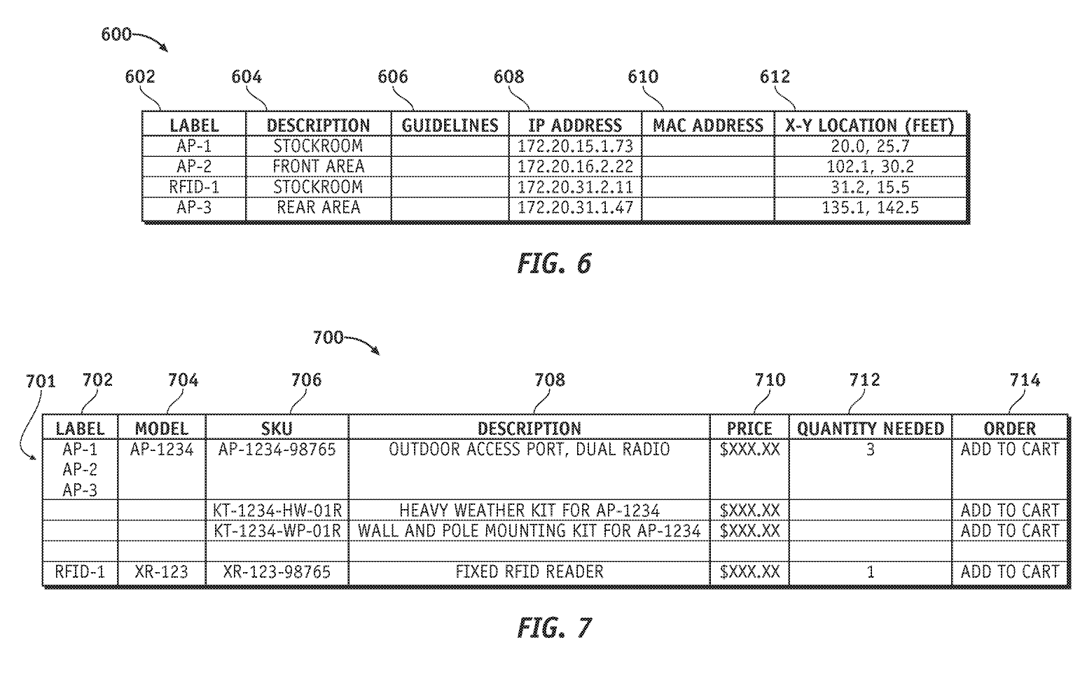

The report generated during task 516 may be displayed, printed, and/or transmitted to a destination device (task 518). In practice, the report can be used as a convenient tool for initiating a purchase order. In certain embodiments, WLAN planning process 500 is suitably designed to generate one or more active ordering links that accommodate online purchasing of the wireless infrastructure components contained in the report (task 520). This optional task is desirable when the host computing device has network connectivity to an appropriate online or remote ordering system. As used here, an active ordering link is any graphically generated user interface control that supports user interaction. For example, active ordering links may be implemented as URL links to an online shopping cart. In certain embodiments, these active ordering links are rendered on the report itself, as depicted in FIG. 7. In response to user interaction with an active ordering link (query task 522), process 500 can initiate a corresponding purchase transaction for at least some of the wireless infrastructure components contained in the report (task 524). The purchase transaction may be executed by an appropriate server based system, for example, a system maintained and operated by the manufacturer or supplier of the wireless infrastructure components. This feature makes WLAN planning and deployment convenient by allowing the network administrator to quickly and seamlessly transition from the planning stage to the product ordering stage. Process 500 can end after a purchase has been initiated or after the report is generated.

FIG. 6 is a simplified representation of a device layout report 600 generated by an embodiment of a WLAN planning system, and FIG. 7 is a simplified representation of a product listing report 700 generated by an embodiment of a WLAN planning system. These reports can be generated, displayed, printed, and/or transmitted during WLAN planning process 500, as described above. Device layout report 600 generally corresponds to the recommended floor plan layout. In this regard, device layout report 600 provides a listing of all recommended wireless infrastructure devices, regardless of how many of the same model number are deployed. Thus, device layout report 600 may include, without limitation: a Label field 602 that provides a unique label for each wireless infrastructure device; a Description field 604 that provides a brief description of each device; a Guidelines field 606 for administrator-defined use or installation rules, recommendations, or configuration settings (for example, to specify that a particular antenna is facing north); an IP Address field 608 that indicates the IP address of each device; a MAC Address field 610 that indicates the network MAC address of each device; and a Location field 612 that indicates the physical location of each device in the floor plan, in Cartesian coordinates relative to an origin point on the floor plan. Of course, the actual content and format of device layout report 600 may vary from that depicted in FIG. 6.

Product listing report 700 includes entries for the recommended wireless infrastructure devices and their recommended accessories (which may be optional). In contrast to device layout report 600, product listing report 700 may combine identical products together into one line item. For example, the first row 701 in product listing report 700 corresponds to three wireless access devices having the same model number and SKU. For this embodiment, product listing report 700 contains, without limitation: a Label field 702 for the device labels; a Model field 704 that lists the model identifier codes for the devices; an SKU field 706 that lists the SKU codes for the devices; a Description field 708 that provides a brief description of the products; a Price field 710 that lists the purchase price for the products; a Quantity Needed field 712 that indicates the number of units required for each SKU code; and an Order field 714 that contains active ordering links for purposes of online ordering. In practice, the active ordering links contained in Order field 714 allow the operator to launch an online purchase transaction for the listed products. The WLAN planning system described herein can leverage well known online shopping cart techniques and technologies that enable the user to adjust quantities, add and subtract items from the online shopping cart, save an order for purchase at a later time, place an order, etc. Of course, the actual content and format of product listing report 700 may vary from that depicted in FIG. 7.

While at least one exemplary embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of planning a wireless network architecture for a site, the method comprising:
receiving floor plan data corresponding to the site;
producing, in response to the floor plan data, a proposed wireless network architecture for the site, the proposed wireless network architecture being deployable using wireless infrastructure components;
obtaining product identifier codes corresponding to the wireless infrastructure components; and
generating a report that lists the product identifier codes.

2. The method of claim 1, further comprising obtaining pricing data for the wireless infrastructure components, wherein generating a report comprises generating a report that lists the product identifier codes and the pricing data.

3. The method of claim 1, further comprising printing the report.

4. The method of claim 1, further comprising displaying the report.

5. The method of claim 1, further comprising generating an active ordering link that accommodates online purchasing of the wireless infrastructure components contained in the report.

6. The method of claim 5, further comprising initiating, in response to user interaction with the active ordering link, a purchase transaction for at least some of the wireless infrastructure components contained in the report.

7. The method of claim 1, wherein obtaining product identifier codes comprises obtaining the product identifier codes from a remote database.

8. The method of claim 1, wherein generating a report comprises generating a report that lists the product identifier codes and quantity data for the wireless infrastructure components.

9. The method of claim 1, wherein generating a report comprises generating a report that lists the product identifier codes and associated model identifier codes for the wireless infrastructure components.

10. A computer-readable medium having stored thereon computer-executable instructions for performing a method of planning a wireless network architecture for a site, the method comprising:
receiving floor plan data corresponding to the site;
producing, in response to the floor plan data, a proposed wireless network architecture for the site, the proposed wireless network architecture being deployable using wireless infrastructure components;
obtaining product identifier codes corresponding to the wireless infrastructure components; and
generating a report that lists the product identifier codes.

11. The computer-readable medium of claim 10, wherein the report also lists pricing data associated with the wireless infrastructure components.

12. The computer-readable medium of claim 10, wherein the report also lists model identifier codes for the wireless infrastructure components.

13. The computer-readable medium of claim 10, further comprising computer-executable instructions for performing the step of generating active ordering links that accommodate online purchasing of the wireless infrastructure components contained in the report.

14. The computer-readable medium of claim 10, further comprising computer-executable instructions for performing the step of obtaining the product identifier codes from a remote database.

15. The computer-readable medium of claim 10, further comprising computer-executable instructions for performing the step of obtaining the product identifier codes from a local database.

16. A computer-executable method of planning a wireless network architecture for a site, the method comprising:
processing floor plan data and desired wireless coverage characteristics for the site;
in response to the processing step, recommending a plurality of wireless infrastructure components for deployment at the site;
obtaining product identifier codes corresponding to the wireless infrastructure components; and
generating a report that lists the product identifier codes.

17. The method of claim 16, further comprising obtaining pricing data for the wireless infrastructure components, wherein generating a report comprises generating a report that lists the product identifier codes and the respective pricing data.

18. The method of claim 16, wherein:
recommending a plurality of wireless infrastructure components comprises recommending a wireless access device and accessories for the wireless access device; and
obtaining product identifier codes comprises obtaining respective product identifier codes for the wireless access device and the accessories.

19. The method of claim 16, wherein:
recommending a plurality of wireless infrastructure components comprises recommending a wireless switch device and accessories for the wireless switch device; and
obtaining product identifier codes comprises obtaining respective product identifier codes for the wireless switch device and the accessories.

20. The method of claim 16, wherein:
recommending a plurality of wireless infrastructure components comprises recommending a radio antenna and accessories for the radio antenna; and
obtaining product identifier codes comprises obtaining respective product identifier codes for the radio antenna and the accessories.
